(19) United States
(12) Patent Application Publication
(10) Pub. No.: US 2011/0300520 A1
(43) Pub. Date: Dec. 8, 2011

(54) SYSTEMS AND METHODS FOR ASSISTING A USER IN ORGANIZING AND WRITING A RESEARCH PAPER

(75) Inventors: Richard H. Harris, Beavercreek, OH (US); James E. Coch, III, Springboro, OH (US); Asger Kunuk Ottar Alstrup, Copenhagen (DK); Joshua B. Murphy, Columbus, OH (US)

(73) Assignee: MEADWESTVACO CORPORATION, Richmond, VA (US)

(21) Appl. No.: 13/152,028

(22) Filed: Jun. 2, 2011

Related U.S. Application Data
(60) Provisional application No. 61/351,698, filed on Jun. 4, 2010.

(51) Int. Cl. G09B 7/00

(52) U.S. Cl. 434/156

(57) ABSTRACT

A system for assisting a user in organizing and writing a research paper. The system includes a thesis module configured to run on a processor and to present a series of questions to the user, receive input regarding the series of questions, and to assemble a thesis statement based on the input received; a research module configured to run on the processor and to output topics related to the thesis statement, to output research notes, and to assemble source citations; an organization module configured to run on the processor and to edit the topics and research notes and to arrange the topics and the research notes within the topics in a predetermined order; and a writing module configured to run on the processor and to create an editable draft of the research paper that includes the thesis statement and the content of the research notes arranged in the predetermined order.

### REFERENCE TO RELATED APPLICATIONS

This application claims the benefit of priority under 35 U.S.C. §119(e) of U.S. provisional application Ser. No. 61/351,698 filed on Jun. 4, 2010, which is hereby incorporated by reference in its entirety.

### COPYRIGHT NOTICE

Portions of the disclosure of this patent document, including the drawings, contain material which is subject to copyright protection. The copyright owner has no objection to the reproduction of the patent document or the patent disclosure, as it appears in the records and files of the U.S. Patent and Trademark Office, but otherwise reserves all copyrights whatsoever.

### BACKGROUND OF THE INVENTION

1. Field of the Invention

The present invention relates to computer-implemented systems and methods for assisting a user in a writing project. More particularly, the present invention is directed to systems and methods for guiding a user through the steps of planning, researching, organizing, and writing a research paper.

2. Description of Related Art

Learning to write effectively is an important life skill. But acquiring this skill is difficult; it takes practice as well as careful guidance from teachers or other mentors. For many students, the research paper is their first introduction to analytical or persuasive writing. Most students are overwhelmed by the immensity of the task; the prospect of planning, researching, organizing, outlining, and finally writing a large-scale project such as a research paper seems intimidating, if not impossible. Even the brightest students may get bogged down in the details of crafting a concise and defensible thesis statement, finding sources that adequately support the thesis, properly paraphrasing reference sources to avoid plagiarism, organizing the paraphrased reference sources in a logical way, and finally putting it all together in a coherent and persuasive paper.

Despite their best intentions, teachers often do not have the time or energy to provide the personalized attention that students need to become more effective writers. Teachers often are forced to spend so much time teaching the structural and organizational aspects of researching, organizing, and outlining a research paper that there is little time left to focus on the most important, and most rewarding task—making their students better writers.

There is a compelling need for methods and systems that help students plan, organize, and write better research papers. Such systems and methods should be easy to use, and self-guiding to the student users from beginning to end of the process. The present invention is directed to methods and systems that meet this need.

### SUMMARY OF THE INVENTION

The invention includes a system for assisting a user in organizing and writing a research paper. In accordance with one embodiment of the invention, the system includes a computer having a processor, a memory device, and a user interface. The computer is configured to run a plurality of modules and to receive input and provide output through the user interface. The modules include a thesis module configured to run on the processor and to present a series of questions to the user, receive input regarding the series of questions, and to assemble a thesis statement based on the input received; a research module configured to run on the processor and to output topics related to the thesis statement based on input from the user, to output research notes based on input from the user, and to assemble source citations based on input from the user; an organization module configured to run on the processor and to edit the topics and research notes and to arrange the topics and the research notes within the topics in a predetermined order; and a writing module configured to run on the processor and to create an editable draft of the research paper that includes the thesis statement and the content of the research notes arranged in the predetermined order. The research module associates each of the research notes with at least one of the source citations.

In an alternate embodiment of the invention, a server may include the processor and a database. A client device is connected to the server by a network to create a user interface. The server is configured to run the plurality of modules and to receive input and provide output through the user interface. The network may be a company intranet or other local area network, a wide area network, or the Internet. The client device may include a computer, a mobile phone, or any other network-enabled device.

A tangible computer readable medium storing an executable program is also disclosed. The executable program is configured to implement a method for assisting a user in organizing and writing a research paper. The method includes the following steps: presenting a series of questions to a user; receiving input from the user for each of the questions; assembling a thesis statement based on the input received from the user; outputting topics based on input received from the user, the topics being related to the thesis statement; creating source citations based on input from the user; creating research notes based on input from the user; associating each of the research notes with at least one of the source citations; presenting a interactive graphical display configured to allow a user to arrange the topics in a predetermined order and to edit the research notes; and creating an editable draft of the research paper that includes the thesis statement and the content of the research notes arranged in the predetermined order. The tangible computer readable medium may be a portable universal serial bus (USB) drive.

A computer-implemented method of assisting a user in organizing and writing a research paper is also disclosed. The method includes the steps of: displaying an interactive graphical display on a computer having a processor and a memory device; running a thesis module using the processor, the thesis module configured to present a series of questions to the user and to receive input regarding the series of questions through the interactive graphical display; using the processor to assemble a thesis statement based on the input received from the user; running a research module using the processor; running an organization module using the processor; and running a writing module using the processor. The research module is configured to create topics related to the thesis statement based on input from the user, to create research notes based on input from the user, to create source citations based on input from the user, and to associate each of the research notes with at least one of the source citations. The organization module is configured to present the topics in a predetermined order through the interactive graphical display and to allow the user to rearrange the topics in any order and to edit the research notes. The writing module is configured to create an editable draft of the research paper that includes the thesis statement and the content of the research notes arranged according to the predetermined order.

### BRIEF DESCRIPTION OF THE DRAWINGS

So that those skilled in the art will readily understand how to implement the systems and methods for assisting a user in organizing and writing a research paper without undue experimentation, preferred embodiments of the systems and methods will be described in detail below with reference to the following figures:

FIG. 1 is a schematic view of the system for assisting a user in organizing and writing a research paper, with the system being implement using a tangible computer-readable medium.

FIG. 2 is a schematic view of the system for assisting a user in organizing and writing a research paper, with the system being implemented over a network.

FIG. 3 illustrates a homepage of the user interface that forms a part of the system of the present invention.

FIG. 4 illustrates an information entry page of the user interface that forms a part of the system of the present invention.

FIG. 5 illustrates a timeline page of the user interface that forms a part of the system of the present invention.

FIG. 6 illustrates a topic selection page of the user interface that forms a part of the system of the present invention.

FIG. 7 illustrates a thesis creation page of the user interface that forms a part of the system of the present invention.

FIG. 8 illustrates a New Thesis window of the user interface that forms a part of the system of the present invention.

FIG. 9 illustrates a Self Assessment page of the user interface that forms a part of the system of the present invention.

FIG. 10 illustrates a sub-topic entry page of the user interface that forms a part of the system of the present invention.

FIG. 11 illustrates a sources page of the user interface that forms a part of the system of the present invention.

FIG. 12 illustrates an Add New Source window of the user interface that forms a part of the system of the present invention.

FIG. 13 illustrates an Add Cards for Source window of the user interface that forms a part of the system of the present invention.

FIG. 14 illustrates a Research Card Edit window of the user interface that forms a part of the system of the present invention.

FIG. 15 illustrates an outline order page of the user interface that forms a part of the system of the present invention.

FIG. 16 illustrates a research organization page of the user interface that forms a part of the system of the present invention.

FIG. 17 illustrates an outline organization page of the user interface that forms a part of the system of the present invention.

FIG. 18 illustrates an introduction writing page of the user interface that forms a part of the system of the present invention.

FIG. 19 illustrates a body paragraph writing page of the user interface that forms a part of the system of the present invention.

FIG. 20 illustrates an Insert Citation window of the user interface that forms a part of the system of the present invention.

FIG. 21 illustrates an outline view of the user interface that forms a part of the system of the present invention.

FIG. 22 illustrates a conclusion writing page of the user interface that forms a part of the system of the present invention.

### DETAILED DESCRIPTION OF PREFERRED EMBODIMENTS

Reference will now be made in detail to the present preferred embodiments of the research paper assistance systems and methods of the present invention, examples of which are illustrated in the accompanying drawings.

The present invention provides students with a user-friendly, engaging and accessible technology platform that provides guidance and support for completing a complex assignment such as a research paper. The system allows students to self-pace while providing the necessary structure to successfully complete the research paper within the assigned time. The system provides an intuitive interface that allows students to immediately start organizing and writing the research paper without the need for instructions or training. The system also builds student confidence by breaking down the complex task of writing a research paper into manageable sub tasks, and by providing self-assessment check points along the way that allow the student to stay on track or to seek help when needed.

In one exemplary embodiment, the system guides students through a six-step process for creating a research paper: planning a schedule, establishing a topic and thesis statement, gathering information and sources, organizing information, creating an outline, and writing the paper. The number of steps is illustrative; each step may be broken up or combined in any suitable manner.

By guiding students through the organization process, the system enables teachers to inspire students to be better writers by focusing on the nuances of style, voice, tone, and argument rather than focusing on the cumbersome structural details of the writing process. The system is designed to seamlessly fit within an existing curriculum and to complement what teachers are already doing. It allows for flexibility when creating a new piece of writing, but offers extra help along the way. The system gives students the power to self-direct their work, while providing guidance along the way to prevent the frustration and confusion that often accompany student attempts to complete large writing assignments.

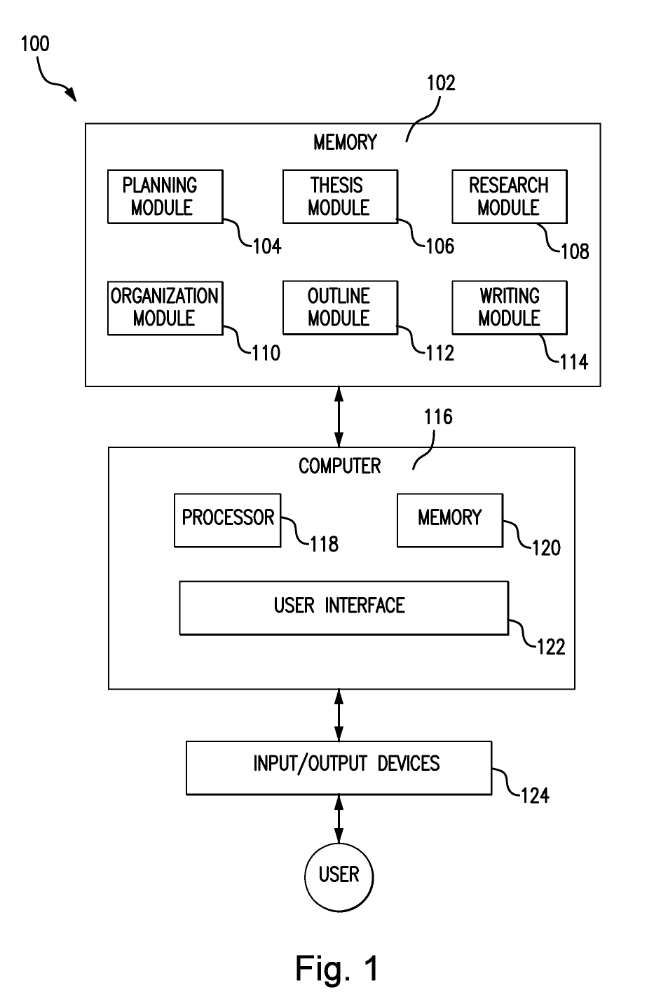

For purposes of explanation and illustration, and not limitation, an exemplary embodiment of a system in accordance with the present invention is shown in FIG. 1 and designated generally by the reference numeral 100. System 100 may include a tangible, computer-readable medium having a memory 102 storing an executable program. In one exemplary embodiment, the computer-readable medium is a portable universal serial bus (USB) drive. Memory 102 may include a plurality of modules, including a planning module 104, a thesis module 106, a research module 108, an organization module 110, an outline module 112, and a writing module 114. System 100 also includes a computer 116 having a processor 118 and a memory 120. Computer 116 interfaces with memory 102 of the computer-readable medium to run the executable program using processor 118. Computer 116 also includes a user interface 122. User interface 122 may include both software and hardware components. For example, computer 116 may be in communication with one or more input and output devices 124, which allow a user to interact with system 100.

System 100 may comprise software components running on computer 116. Computer 116 may run any suitable operating system and may include a variety of hardware configurations. Processor 118 may be coupled to memory 120 module and to a mass storage device via a bus or other communication medium. Input/output devices 124 may include a display or other output device interfacing with the processor, a keyboard, mouse, touchpad, or other input device that receives input from the user and interfaces with processor 118.

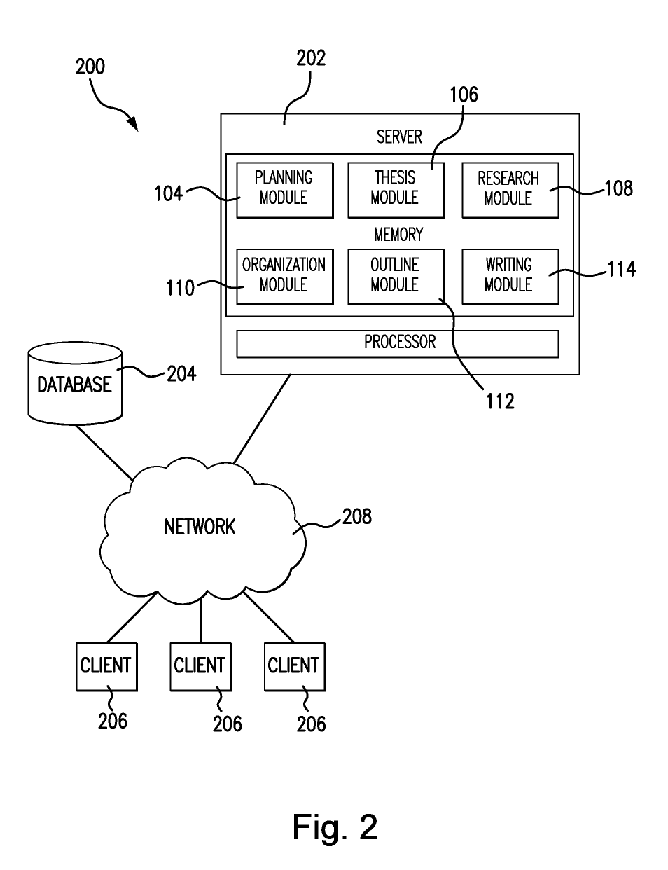

FIG. 2 illustrates another exemplary embodiment of a system in accordance with the present invention, designated generally by the reference numeral 200. System 200 allows a user to use the research paper assistance program through a network rather than through a local memory device, as described above with regard to system 100. System 200 may include a server computer 202, a database 204, and a plurality of client devices 206. Database 204, server computer 202, and client devices 206 may interface with one another via a network 208. Network 208 may be any suitable network, including a company or school intranet or other local area network, a wide area network, and the Internet. Server 202 may include a plurality of servers, and database 204 may include a plurality of databases. Client devices may include a computer, a mobile phone, or any other network-enabled device. Depending upon the architecture of the system 200, the user interface may be provided by server 202 and/or client devices 206.

System 200 may comprise software components running on either service management server 202 or client devices 206. Server 202 and client devices 206 may run any suitable operating system and may include a variety of hardware configurations. Both server 202 and client devices 206 may include a processor coupled to a memory module and to a mass storage device via a bus or other communication medium; a display or other output device interfacing with the processor; and a keyboard, mouse, touchpad, or other input device that receives input from a user and interfaces with the processor. In one exemplary embodiment, client devices 206 each include an input device for receiving user input and a display device for displaying content. The software implementing system 200 may include instructions written in a high level computer language and stored in a mass storage device. In one exemplary embodiment, a plurality of modules having distinct functions run on server 202.

The functionality described in this disclosure is applicable to both embodiments of the research paper assistance system. For example, server 202 of system 200 may run the same modules as are run on a local memory device in system 100, including planning module 104, thesis module 106, research module 108, organization module 110, outline module 112, and writing module 114. Although the research paper assistance system will be described with reference to system 100, it should be understood that system 200, or any other embodiment of the described invention may be used to carry out the research paper assistance methods and systems.

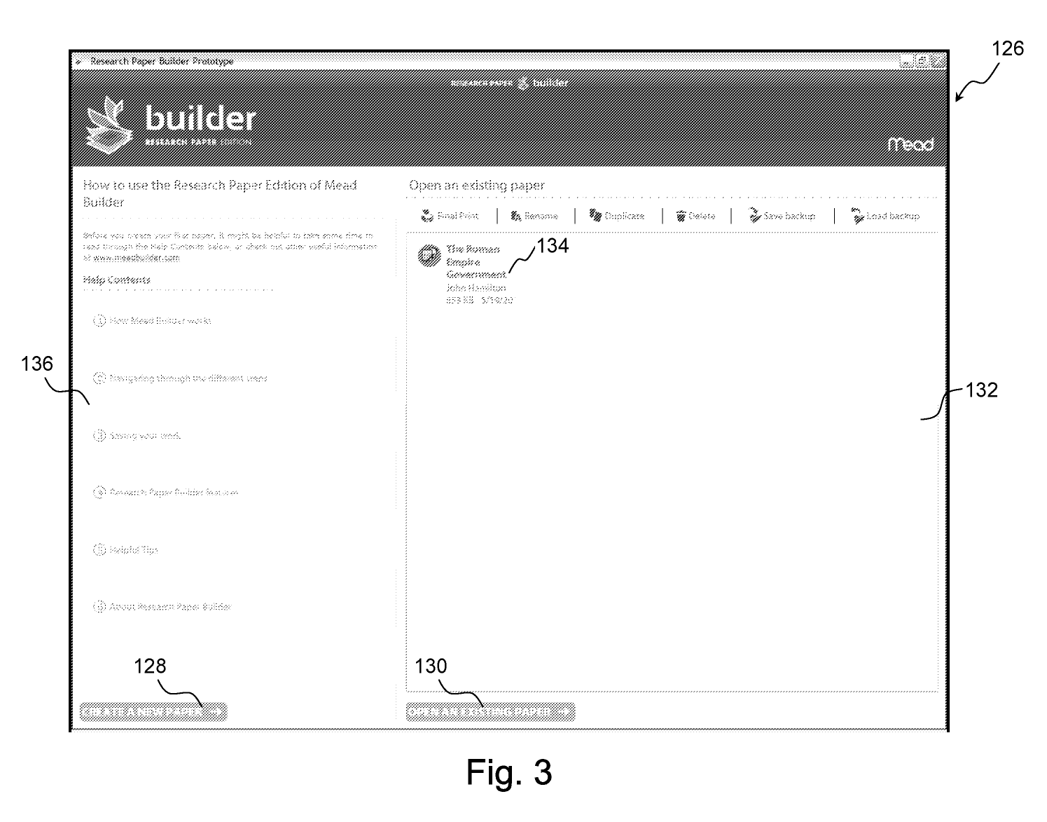

User interface 122 of system 100 may include a graphical user interface. FIG. 3 illustrates a portion of a graphical user interface of an exemplary embodiment of system 100. By running the executable program stored on memory 102 using processor 118, a user will be able to access a homepage 126, as shown in FIG. 3. Homepage 126 is a starting point for the user and includes a plurality of links or buttons that may be selected by the user to carry our various functions. A Create button 128 allows the user to create a new research paper project; an Open Existing button 130 allows the user to open a previously saved research paper project. A project selection area 132 of homepage 126 may include project icons 134 representing saved research paper projects. Project icons 134 may include information regarding the research paper project such as the title of the paper, the user's name, the size of the file, and the date the project was created. Project selection area 132 may also include functionality for printing, renaming, duplicating or deleting a research paper project. The user may continue working on a previously saved project by selecting a project icon 134 from within project selection area 132, and then selecting the Open Existing button 130.

Homepage 126 may also include a help section 136 with a plurality of selectable links that provide the user with additional information regarding system 100. This information may be presented to the user using pop-up windows, by linking directly to a web page on the Internet, or by any other suitable means.

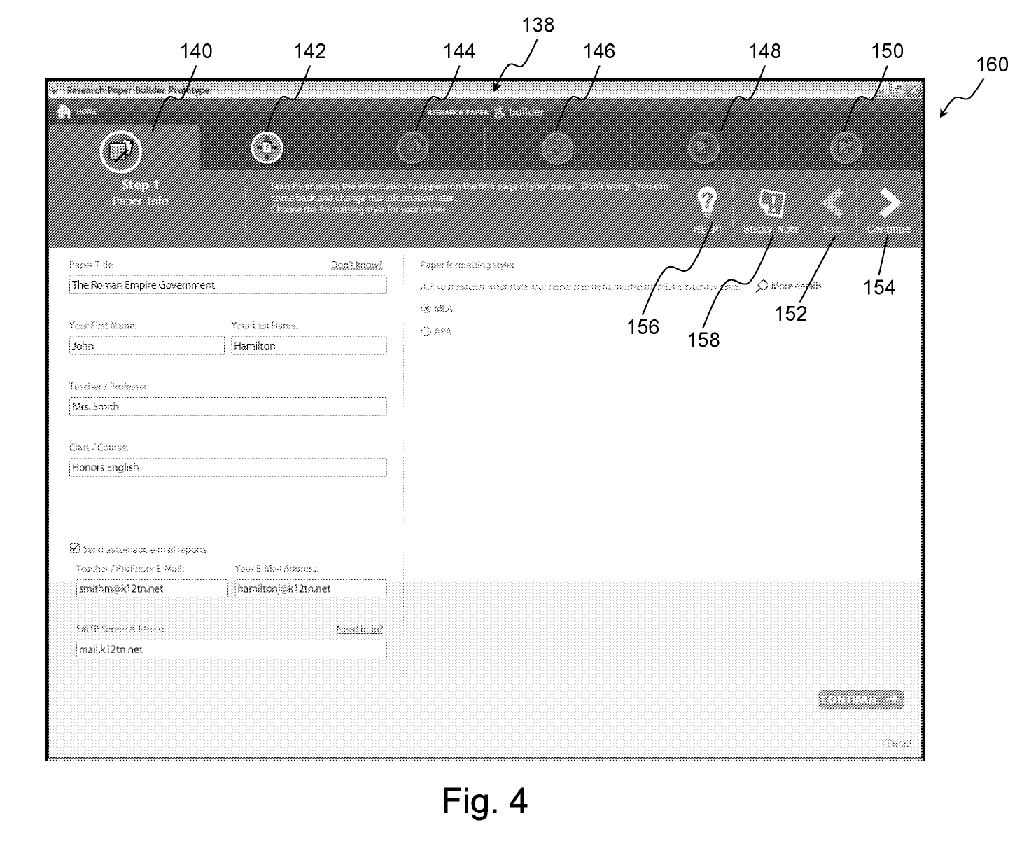

The graphical user interface of system 100 may include functionality that allows a user to easily move step-by-step through the process of writing a research paper, including the steps of planning the paper, writing a thesis statement, researching the thesis statement, organizing the paper, outlining the paper, and finally, writing each section of the paper. For example, as shown in FIG. 4, the graphical user interface may include a plurality of selectable tabs 138, with each tab corresponding to one of the six steps: a planning tab 140, a thesis tab 142, a research tab 144, an organization tab 146, an outline tab 148, and a writing tab 150. The functionality contained within each of selectable tabs 138 is connected to one or more of the modules contained within memory 102.

For a new research paper project, selectable tabs 138 corresponding to the steps in the process that have yet to be completed for the given research paper project may be presented as faded icons that are not yet selectable, indicating that the user has not yet completed the prerequisite steps needed to access the corresponding step. This forces the user to complete each step of the process in order before moving on to the next step. Once a step has been completed, the selectable tab corresponding to that step will then become selectable. This functionality allows the user to easily navigate to previously completed steps and make any necessary changes.

Each tab may include one or more pages that can be navigated using Back button 152 and Continue button 154. These buttons may also be used to navigate between selectable tabs 138. The graphical user interface may also include a Help button 156 and a Sticky Note button 158. Selecting Help button 156 will provide the user with specific help relating to the page that is currently being displayed. Selecting the Sticky Note button 158 will allow a user to write a note that can be saved and later referred to by again selecting the button.

Selecting the Create button 128 on homepage 126 creates a new file for a research paper project and takes the user to an information entry page 160 within the graphical user interface, as shown in FIG. 4. Information entry page 160 allows the user to enter the information that will appear on the title page of the research paper. The page may include text fields or other suitable means for entering information such as the title of the paper, the first and last name of the student, and name of the teacher or professor, and the name of the class or course. Information entry page 160 may also include a selectable option for sending automatic email reports. If a user selects this option, text fields will appear on information entry page 160 that allow the user to enter information regarding the email address of the user and the email address of the recipient, for example a teacher. There may also be an option for entering information regarding the address of the Simple Mail Transfer Protocol (SMTP) server associated with the user's email address. Once this information has been entered, system 100 may be configured to automatically send reports to a teacher, parent, or other individual as the user progresses through the steps of completing the research paper project. In one exemplary embodiment, the reports are sent automatically upon completion of predetermined steps. In another exemplary embodiment, the user must initiate the sending of a report.

Information entry page 160 may also include functionality for selecting a paper formatting style using a text box, radio buttons, drop down menus, or any other suitable means. For example, as shown in FIG. 4, the user may be able to choose between formatting the research paper according to the MLA (Modern Language Association) style or according to the APA (American Psychological Association) style. These styles are given as examples; system 100 may be adapted to select any suitable formatting style and to automatically format the research paper accordingly.

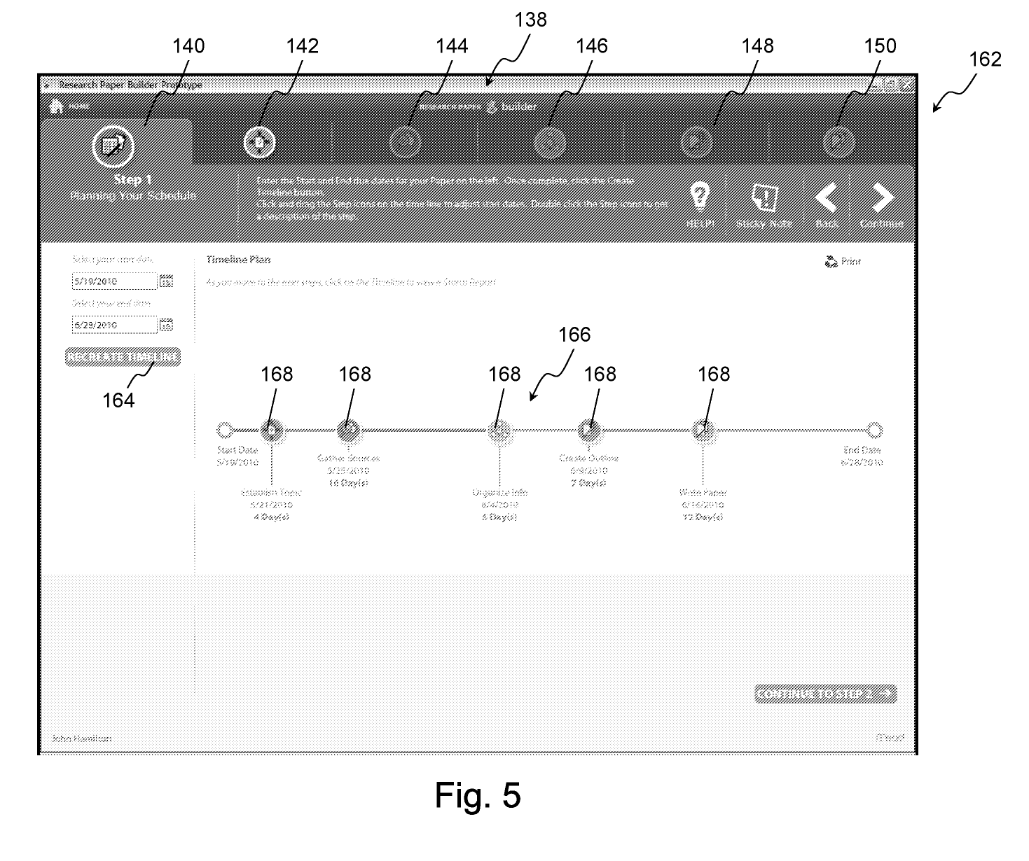

FIG. 5 illustrates a timeline page 162 accessible within the planning tab 140. Timeline page 162 is presented to the user after the user has entered the information requested on information entry page 160. Timeline page 162 includes functionality that allows the user to enter a start date and a completion date for a research paper project. Once the start date and the completion date have been entered, and the user has clicked on a Create Timeline button 164, system 100 displays a timeline 166 that includes both the start date and the completion date. Timeline 166 may also include a plurality of intermediate deadlines. The intermediate deadlines may be customizable and may correspond to the steps in the process represented by selectable tabs 138.

In one exemplary embodiment, the timeline is presented in an interactive format. For example, each of the intermediate deadlines in timeline 166 may be represented as a step icon 168 on the timeline. Once timeline 166 has been created, the user will then be able to select one of the step icons 168 and drag the icon backward or forward in along timeline 166. Each step icon may also be displayed with additional information concerning the step, including the name of the step, the date on which the step is to be completed, and the number of days allotted on the timeline for completion of the step. As the user moves one of the step icons 168 along timeline 166, the date and the number of days allotted to the step will dynamically change, without the need to refresh the page. Each step icon 168 of timeline 166 may be presented to the user in a color that coordinates with the color presented to the user in the corresponding selectable tab 138. Step icons 168 may also include additional functionality. For example, performing a specified action, such as double clicking, on one of the step icons may bring up a help section explaining the corresponding step in the process of writing the research paper.

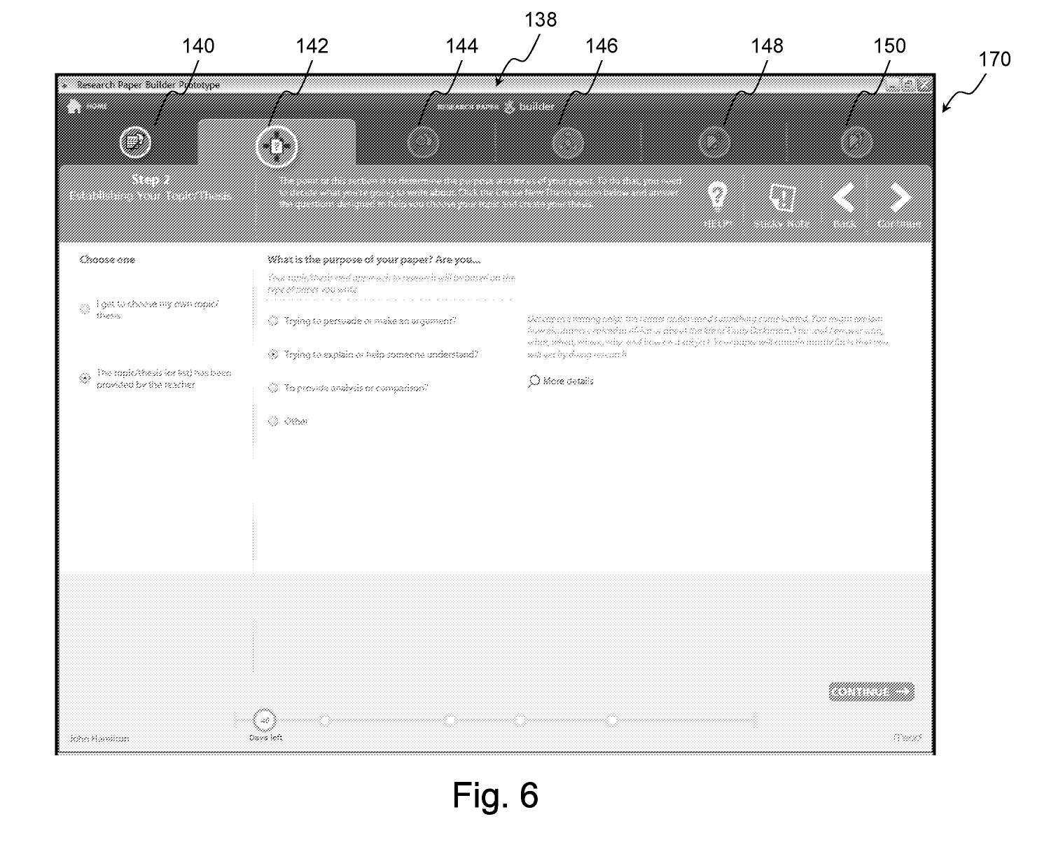

FIG. 6 illustrates a topic selection page 170 accessible within the thesis tab 142. Topic selection page 170 may include one or more questions for the user regarding the purpose of the research paper that is to be written. As the user progresses through each page of the graphical user interface accessed by selectable tabs 138, system 100 will present the user with specific questions and advice for completing each of the steps in the writing process. In one exemplary embodiment, the specific advice given is dependent on the answers received from the user. For example, topic selection page 170 may include the following question: What is the purpose of your paper? with answer choices that include Trying to persuade or make an argument, Trying to explain or help someone understand, and To provide analysis or comparison. As one example, if a user selects Trying to explain or help someone understand, system 100 would then present the user with an explanation of appropriate descriptive writing, thus allowing the user to get a better idea of what the assignment will require. The explanation may include tips and other help provided to the user.

Those skilled in the art will readily appreciate that the type, number, and complexity of the questions asked may be customizable within the software modules running on memory 102 such that system 100 may be tailored for use with a wide variety of users ranging from elementary school students to graduate school students and beyond.

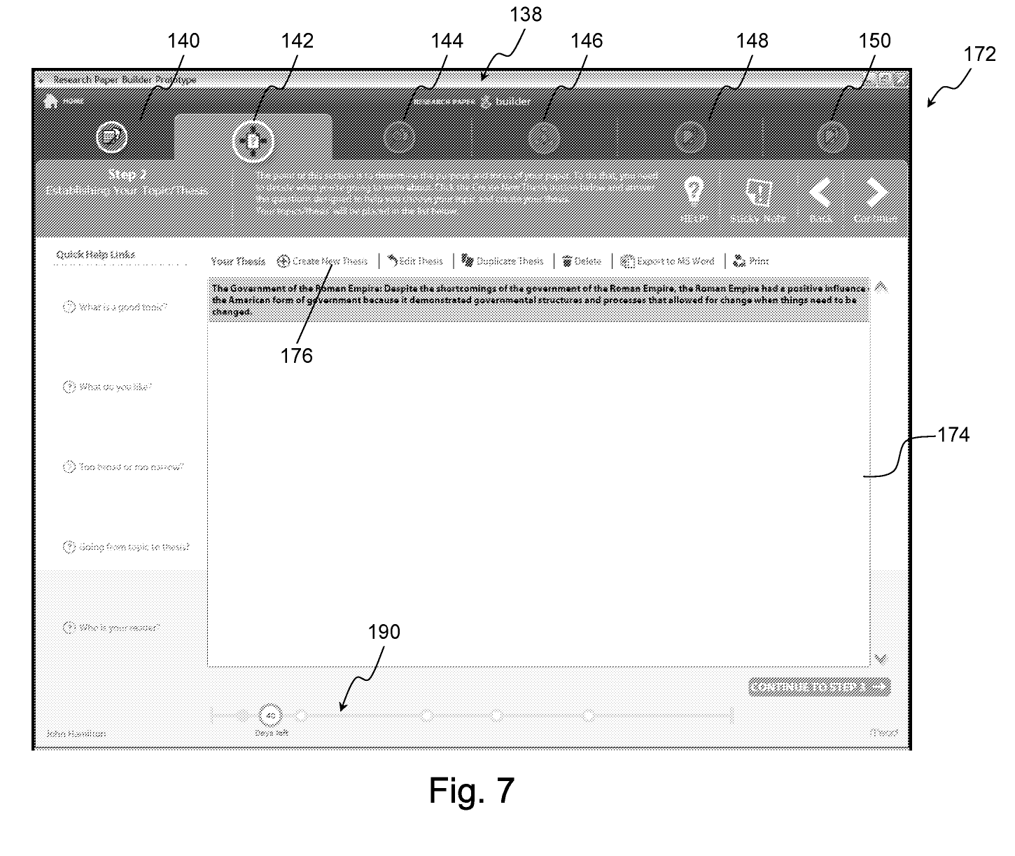

FIG. 7 illustrates a thesis creation page 172 that is presented to a user after topic selection page 170. Thesis creation page 172 may include functionality for creating a new thesis, editing an existing thesis, duplicating a thesis, deleting a thesis, exporting the thesis to a word processing program, and printing a thesis. Thesis creation page aids the student in determining the purpose and focus of the research paper. If a thesis has already been created for the current research paper project, it is shown in a thesis display area 174 of thesis creation page 172. In one exemplary embodiment, the user may be able to create and save multiple theses that will then be displayed and selectable within the thesis display area 174.

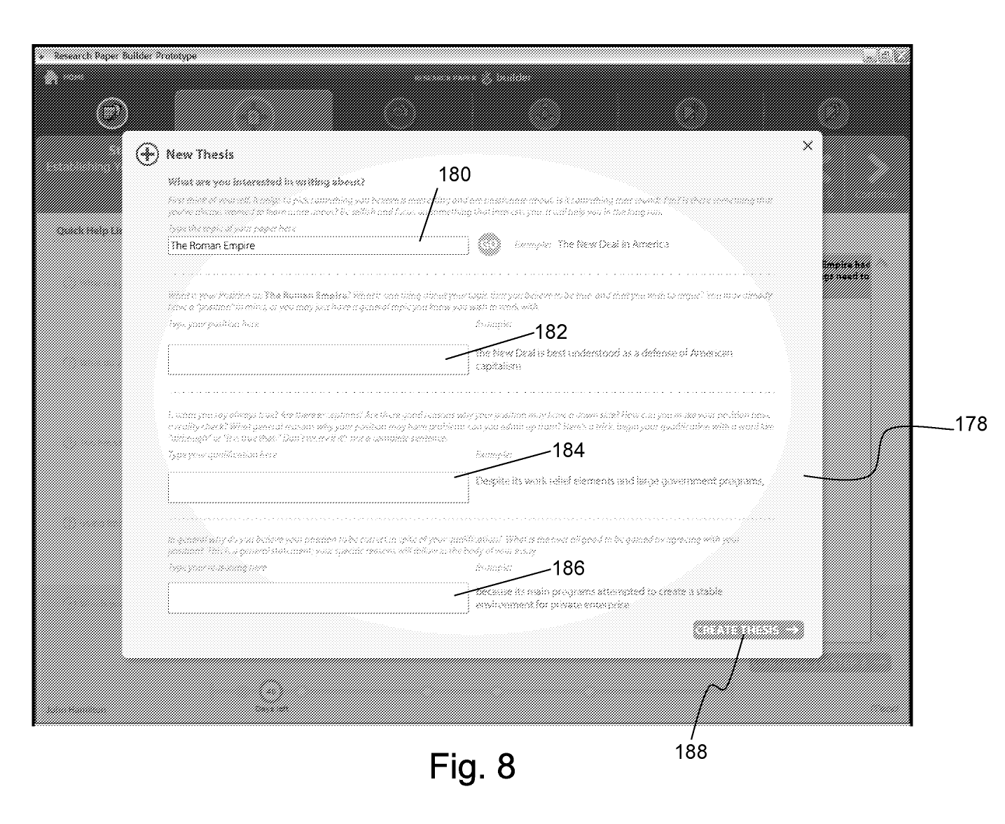

By clicking or otherwise selecting a Create New Thesis button 176, the user will be presented with a new thesis window 178, as shown in FIG. 8. New thesis window 178 may be presented as a pop-up window, as a page accessed from within thesis tab 142, or using any other suitable method. In one exemplary embodiment, new thesis window 178 presents the user with a series of specific questions to guide the user through the process of writing a thesis statement. A plurality of text boxes or other input functionality may be provided, including a topic text box 180, a position text box 182, a qualification text box 184, and a reasoning text box 186. Next to each text box, system 100 may present information to guide the user in entering text into the text box. Once the user has entered the topic, a position on the topic, a qualification regarding the position, and reasoning supporting the position despite the qualification, the user can then select a Create Thesis button 188, which will cause system 100 to automatically generate a thesis statement based on the entered information. In other embodiments, the user may be given an option to simply create a thesis statement (without the series of questions), or to create a thesis statement that is not in three-part form.

As an example, if the user were to enter Oprah Winfrey in topic text box 180, Oprah Winfrey is the most generous celebrity, and she also inspires more generosity than any other celebrity in the position text box 182, there are many other celebrities who are generous and inspiring, into the exception text box 184, and Oprah gives more to charity than any other celebrity, and she also habitually encourages others to give into reasoning text box 186, upon selecting Create Thesis button 188, system 100 would create the following thesis statement based on the qualification, reason, and position inputted by the user: Although there are many other celebrities who are generous and inspiring, Oprah Winfrey is the most generous celebrity, and she also inspires more generosity than any other celebrity. Oprah gives more to charity than any other celebrity and she also habitually encourages others to give. In one exemplary embodiment, the user is then given an opportunity to edit the thesis statement to ensure that it flows smoothly and that proper grammar and spelling are used. Once the user is satisfied with the thesis statement that has been created, the statement is displayed in thesis display area 174 of thesis creation page 172.

On each of the pages of the user interface displayed after timeline page 162, a timeline representation 190, as shown in FIG. 7, for example, may be presented indicating the number of days left until the due date for completion of the research project. Selecting timeline representation 190, as shown in FIG. 7, for example, will allow the user to view a status update page showing the progress the user has made toward the completion of the research paper project.

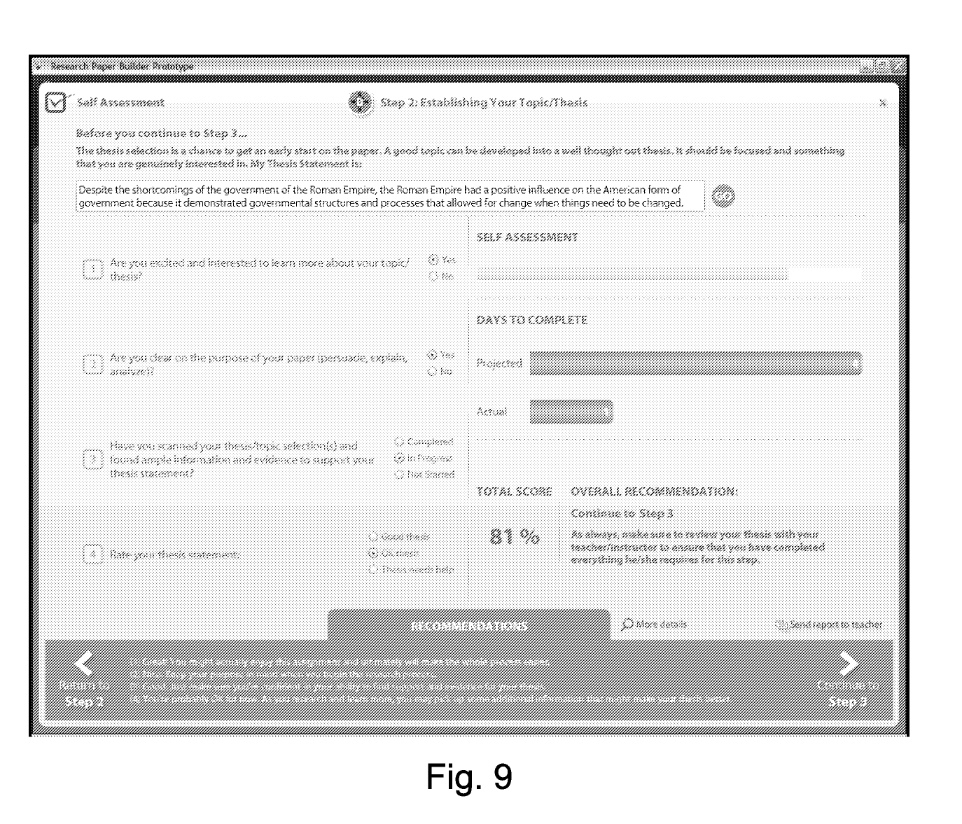

FIG. 9 illustrates an exemplary Self Assessment page 192 that may be presented to the user after each step in the research paper project has been completed, that is, when each of the pages within one of the selectable tabs 138 has been completed by the user. FIG. 9 shows an exemplary embodiment of a Self Assessment page 192 that is presented to the user after completion of the step of creating a thesis statement. However, a Self Assessment page 192 may be presented to the user after completion of any of the tabs, or at any other appropriate time. As shown in FIG. 9, Self Assessment page 192 may include questions presented to the user designed to gauge the completeness and quality of the work done in the previous step. For example, the user may be asked the following questions: Are you excited and interested to learn more about your topic? Are you clear on the purpose of your paper? Have you scanned your thesis and found ample information and evidence in support of your thesis statement? In one exemplary embodiment, the user is able to select an answer from a group. Based on the responses inputted by the user, system 100 will then produce an overall score for the step that has just been completed, and will also provide appropriate recommendations for moving forward or getting more help from a teacher or professor.

Self Assessment page 192 may also display the number of days projected for completion of the step, as determined by timeline 166, as well as the number of days that have actually passed. The overall score may be derived from the number of optimal or nearly optimal answers provided by the user. For example, as shown in FIG. 9, Self Assessment page 192 may include four questions, with each question being assigned a weighted value. The optimal answer to the question Are you excited and interested to learn more about your topic/thesis? is Yes. If a user selects yes, he or she will be awarded the full weighted value for the question, which will increase the overall score. Answering No may result in no value being added toward the overall score.

Some questions may have more than two answer choices, and may allow the user to receive a portion of the weighted value for the question. For example, the question, Rate your thesis statement includes three answer choices. While selecting Good thesis is an optimal answer choice and would result in the user receiving the full weighted value for the question, selecting OK thesis may still result in some value, but the value will be less than the full weighted value for the question. Selecting Thesis needs help may result in an even lesser value or no value at all to be awarded for the question. In one exemplary embodiment, the value awarded for an answer may be tied to the intermediate deadlines in timeline 166.

Combining the weighted values of each of the questions results in the overall score. One skilled in the art will recognize that the Self Assessment page may include any number of questions, with each question being weighted toward the overall score in any appropriate manner. The purpose of the Self Assessment pages presented to the user is to assist the user in evaluating his or her work and making adjustments or improvements where needed.

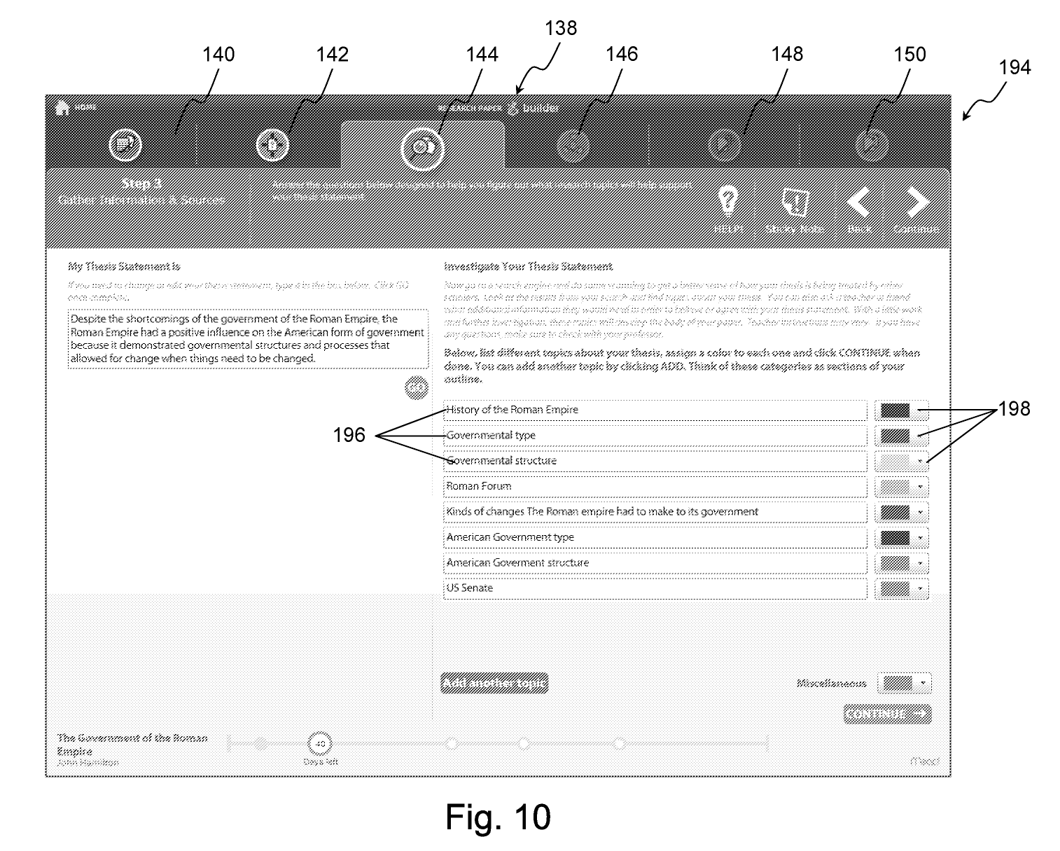

FIG. 10 illustrates a sub-topic entry page 194 accessible within research tab 144. Sub-topic entry page 194 may include functionality for entering sub topics relating to the thesis statement created on thesis creation page 172. In the exemplary embodiment shown, the user enters each sub topic into a sub-topic text field 196 and assigns a color to each sub topic by selecting the color from a pull-down menu 198 adjacent to sub-topic text field 196. Sub-topic entry page 194 may also display the previously created thesis to aid the user in determining appropriate sub topics.

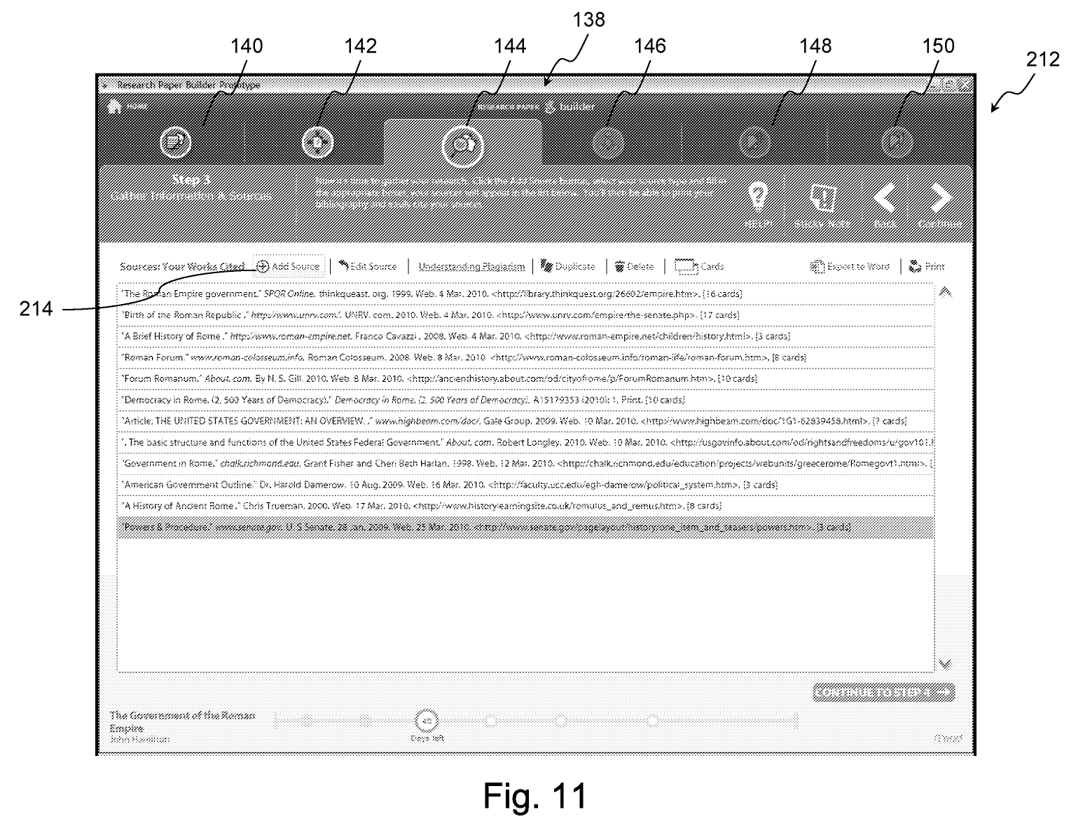

FIG. 11 illustrates a sources page 212 accessible within research tab 144. Sources page 212 includes functionality for adding and editing a source as well as duplicating and deleting a source. Functionality may also be included for exporting the contents of the page to a word processing program and for printing the page. Selecting an Add Source button 214 from within sources page 212 causes system 100 to present an Add New source window 216 to the user.

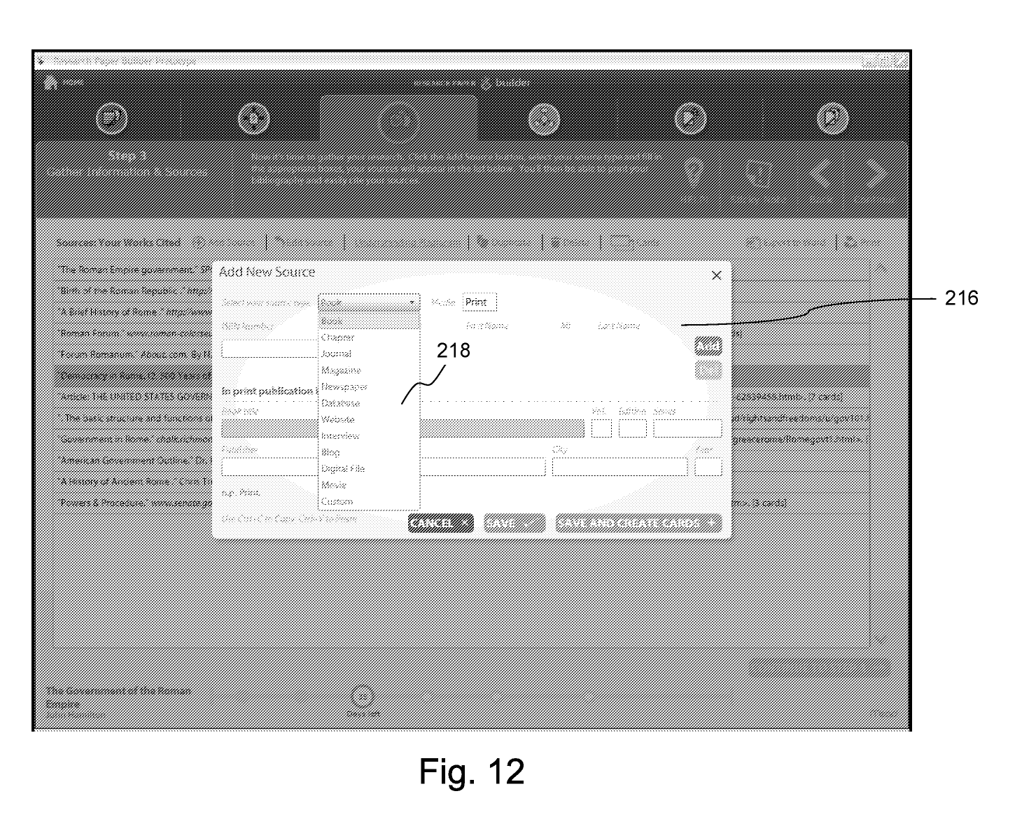

FIG. 12 illustrates an exemplary embodiment of Add New Source window 216, which may include functionality for adding all the information about a reference source for the research paper project that is needed to create a complete bibliography or works cited entry for the paper. Add New Source window 216 may include a source type menu 218, which provides a list of possible source types, including, but not limited to, books, chapters, journals, magazines, newspapers, databases, websites, interviews, blogs, digital files, and movies. When a given source type is selected, Add New Source window 216 is automatically reconfigured with text boxes, drop-down menus, radio buttons, and any other suitable input means for requesting the specific information required for the given source type. For example, when the user selects Book as the source type, Add New Source window 216 may include functionality that allows the user to enter the title of the book, the name of the author, ISBN Number, Publisher, and other relevant information. If the user were to change the source type to Movie, Add New Source window 216 would automatically change to include the relevant information for the a movie, such as the movie title, the producer, director, or other performer in the movie, the name of the studio that distributed the movie, the year the movie was made, and its country of origin. This functionality allows the user to quickly determine what information is needed for each source type without the need to look up the proper formatting style. Add New Source window 216 may be customized to match the paper formatting style selected by the user on information entry page 160. In one exemplary embodiment, source type menu 218 may include a custom selection, which allows the user to enter information for a source that does not fit within one of the predetermined categories.

Referring again to FIG. 11, once a reference source has been added using Add Source button 214, the source will be listed on source page 212. Each of the listed sources may be selectable. In the exemplary embodiment shown in FIG. 11, sources page 212 includes a Cards button 220, which allows the user to create a research card, as will be described in detail below.

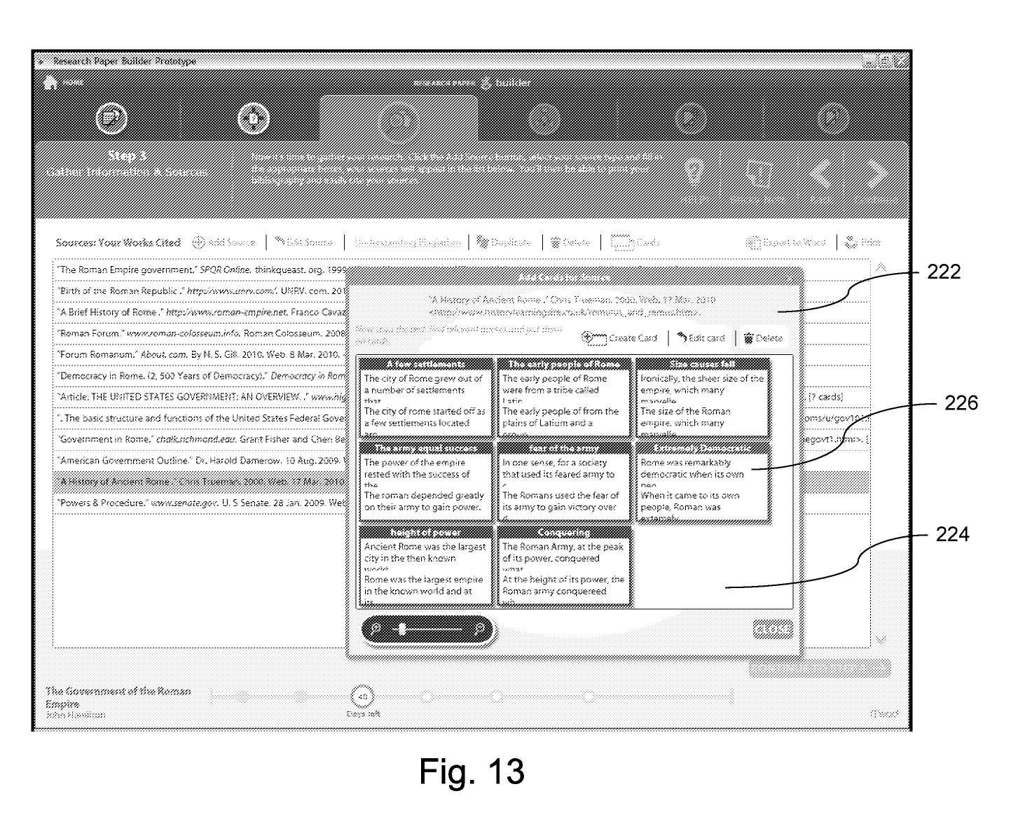

FIG. 13 illustrates an exemplary embodiment of an Add Cards for Source window 222, which is presented to the user by system 100 when a given source is highlighted and the Cards button 220 is selected. Add Cards for Source window 222 may include a description of the selected reference source as well as functionality for creating a card, editing a card, and deleting a card. Add Cards for Source window 222 also includes a research card section 224 displaying the research cards 226 that have been created for the selected research source. Add Cards for Source window 222 may also include functionality for zooming in and out, that is making research cards 226 appear larger or smaller, depending on user preference.

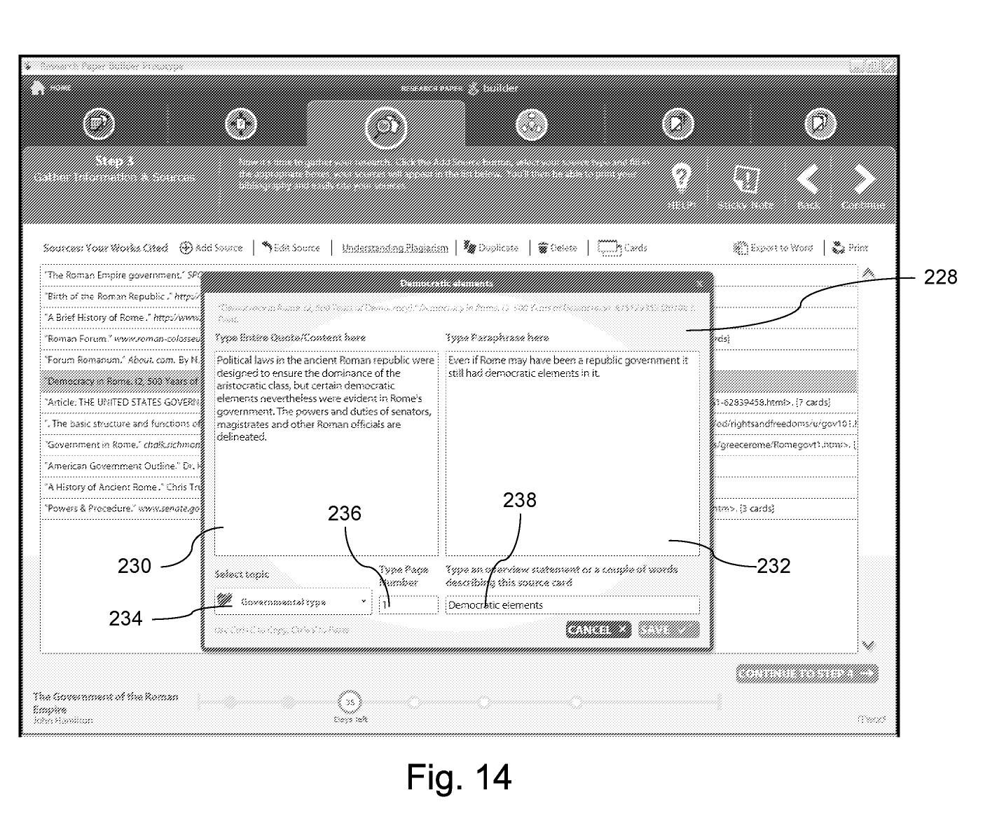

FIG. 14 illustrates a Research Card Edit window 228, which can be accessed by using the functionality for creating a research card from within Add Cards for Source window 222 or by double clicking or otherwise selecting a research card 226 shown in an Add Cards for Source window 222. Research Card Edit window 228 may include two adjacent text boxes: a quote box 230 and a paraphrase box 232. Quote box 230 allows the user to either type in, or cut and paste the entire quote from the selected reference source. Paraphrase box 232 allows the user to enter a paraphrase of the quote. Research Card Edit window 228 may also include a Select Topic menu 234, a page number field 236, and an overview statement field 238. Select Topic menu 234 permits a user to associate the research note that is being created or edited with one of the sub topics created by the user on sub-topic entry page 194 (FIG. 10).

In one exemplary embodiment, when a research note card is associated with a sub topic, that research note card will be highlighted in the color that corresponds to the chosen sub-topic, which was determined on sub-topic entry page 194. If required by the selected formatting standard (i.e., MLA or APA), page number field 236 permits the user to input the page on which the relevant quote is found within the reference source. Overview statement field 238 in Research Card Edit window 228 permits the user to enter a few words describing the source card. The text entered by the user into overview statement field 238 will then appear as a title on the research note card that has been created, allowing the user to quickly view and organize the research note cards on subsequent pages. As will be described in further detail herein, the overview statement may optionally also appear as a subtopic in the outline generated by the system.

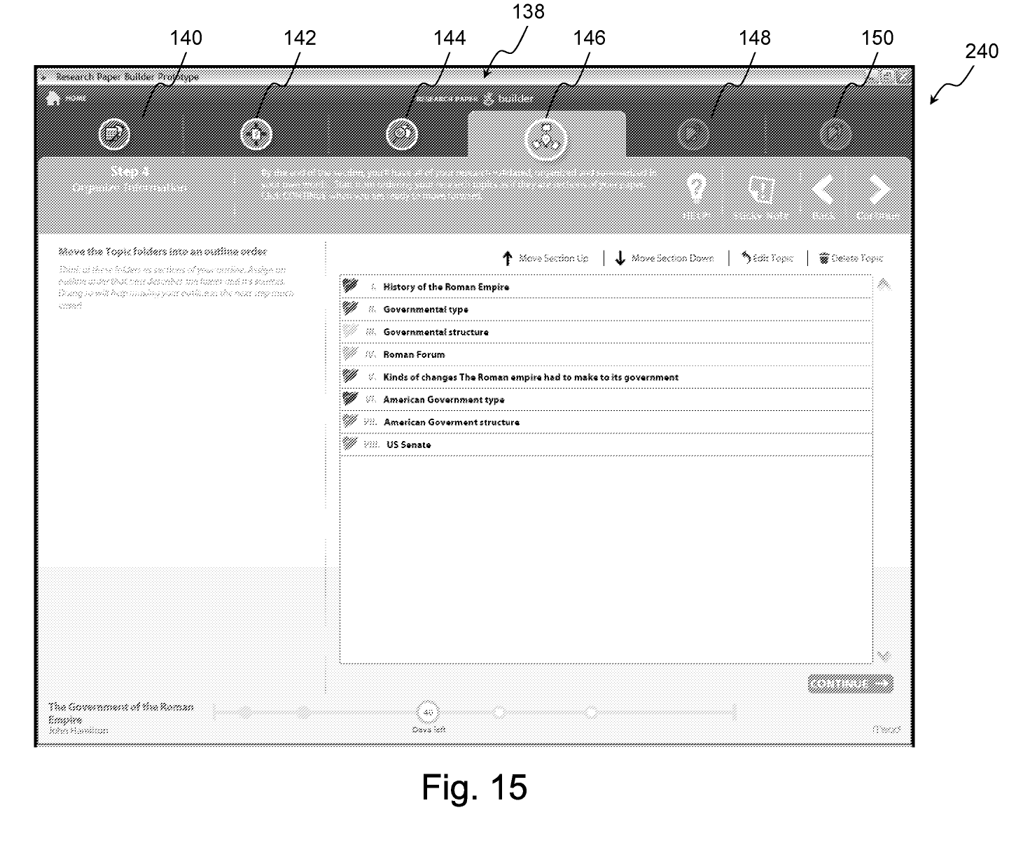

FIG. 15 illustrates an outline order page 240 accessible within organization tab 146. Outline order page 240 may include a list of sub topics corresponding to the sub topics entered into sub-topic text fields 196 of sub-topic entry page 194. Outline order page 240 may also include functionality for rearranging the order of the sub topics in the list. For example, the page may include a Move Section Up button 242 and a Move Section Down button 244. Each of the sub topics represents a section of the outline that will eventually become the finished research paper. By selecting a sub topic listed on the page and by using buttons 242 and 244, the user will be able to assign an outline order that makes the most sense in supporting the thesis statement created using thesis creation page 172.

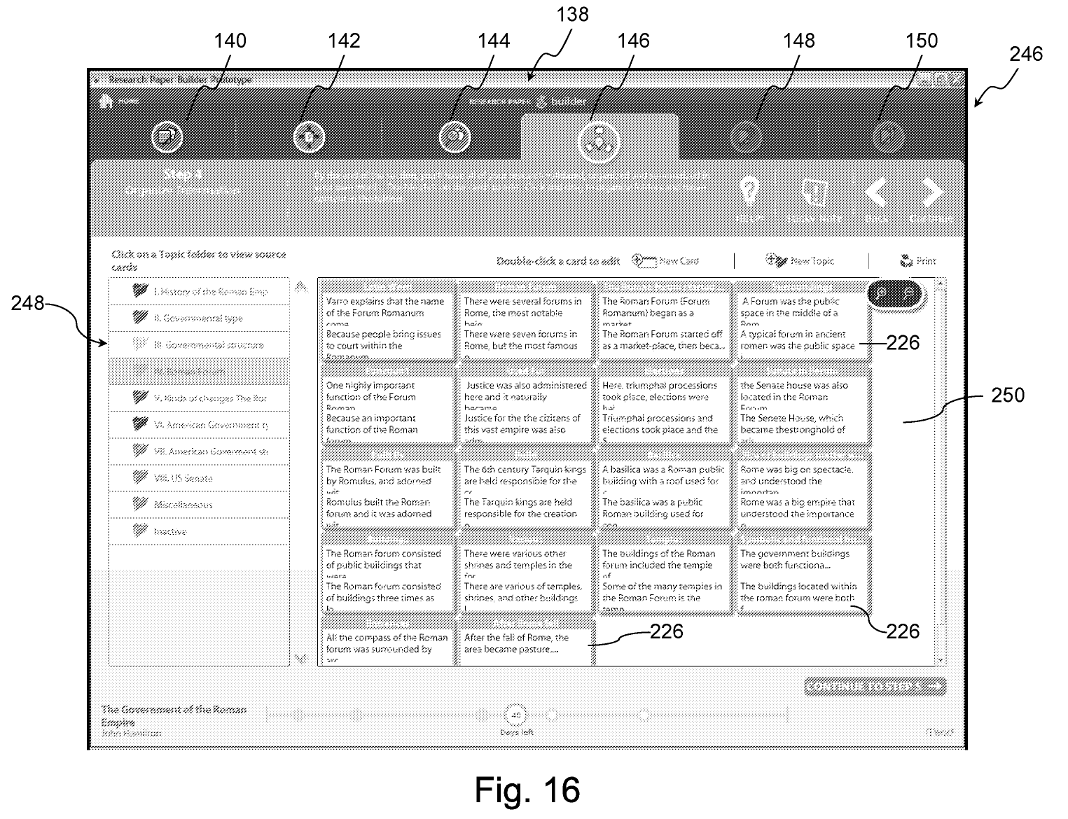

FIG. 16 illustrates a research organization page 246 accessible within organization tab 146. Research organization page 246 includes a topic folder display section 248 and a research card display section 250. Topic folder display section 248 displays a list of sub topics corresponding to the sub topics entered in sub-topic entry page 194. The sub topics are represented as folders. Clicking or otherwise selecting one of the sub topics listed in topic folder display section 248 causes system 100 to display all of the research cards 226 currently associated with the selected sub topic folder. For example, if a sub topic named Roman Forum is selected in topic folder display section 248, as shown in FIG. 16, research card display section 250 will display a representation of all research cards 226 that have been associated with the chosen sub topic. Research card display section 250 also includes functionality for reordering all of the research cards associated with a given sub topic and for moving a research card from one sub-topic folder to another. For example, the user may rearrange the order of the research cards simply by clicking and dragging one of the cards to a new location within research card display section 250. Similarly, the user may move a research card from one sub-topic folder to another simply by clicking and dragging the card from research card display section 250 to the desired sub topic listed in topic folder display section 248 of research organization page 246. The order in which the cards appear within research card display section 250 is the order in which the information on the card will appear in an outline created by system 100 and will be reflected in the order of the issues discussed in the final research paper.

Research organization page 246 may also include functionality for editing the research cards, creating a new research card, creating a new topic, printing the content of the research cards, and resizing the display size of the research cards. (Any changes made at this or a later step will cause the information viewed on a previous page to be correspondingly updated.) Topic folder display section 248 may also include a Miscellaneous folder 252 and an Inactive folder 254, which may be used to hold research cards that the user has yet to organize or which may not be needed for the final research paper.

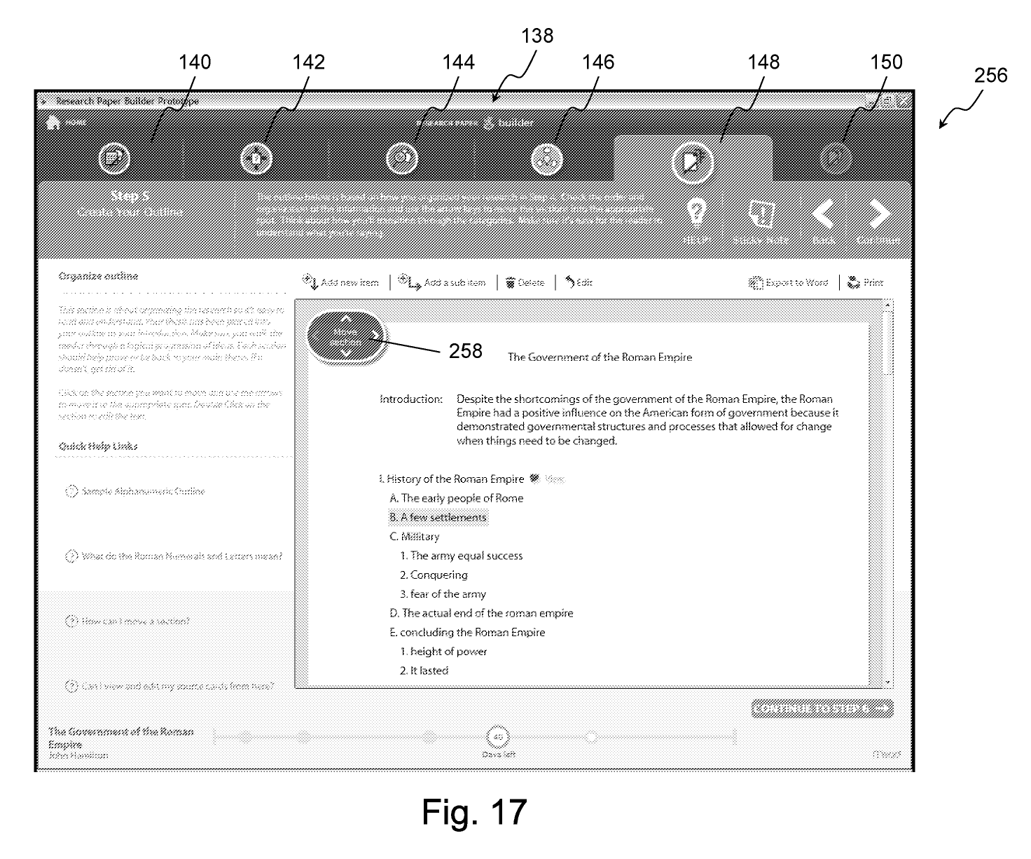

FIG. 17 illustrates an outline organization page 256 accessible from within outline tab 148. This page allows the user to further organize the sub-topic list displayed on research organization page 246 by displaying the sub-topic list in outline form and providing functionality for adding sub items to the outline. As shown in FIG. 17, outline organization page 256 may display an alphanumeric outline relating back to the thesis created by the user. In one exemplary embodiment, Roman numerals are used for each sub topic, capital letters are used for primary support of the sub topic, and lower case letters or numbers are used for more detailed information relating to the primary support.

Outline organization page 256 may include functionality for quickly rearranging the order of items displayed in the outline. In one exemplary embodiment, outline organization page 256 includes an ordering tool 258. In connection with the ordering tool 258, the user may be prompted as to whether they want to insert quote 230 or paraphrase 232, or the contents of overview statement field 238. After the user has selected an item within the outline, ordering tool 258 may be used to move the selected item within the outline. Outline tool 258 may include four arrows, which allow the user to change both the order of the item and its level within the outline. Outline organization page 256 may also include functionality for adding a new item to the displayed outline and adding a sub item to the outline. In addition, functionality may be included for deleting or editing an already existing item in the outline. Once an outline has been created and the content is organized, should a user go back to an earlier step and add or rearrange any cards, the changes will be captured in the outline and appear under the correct topics.

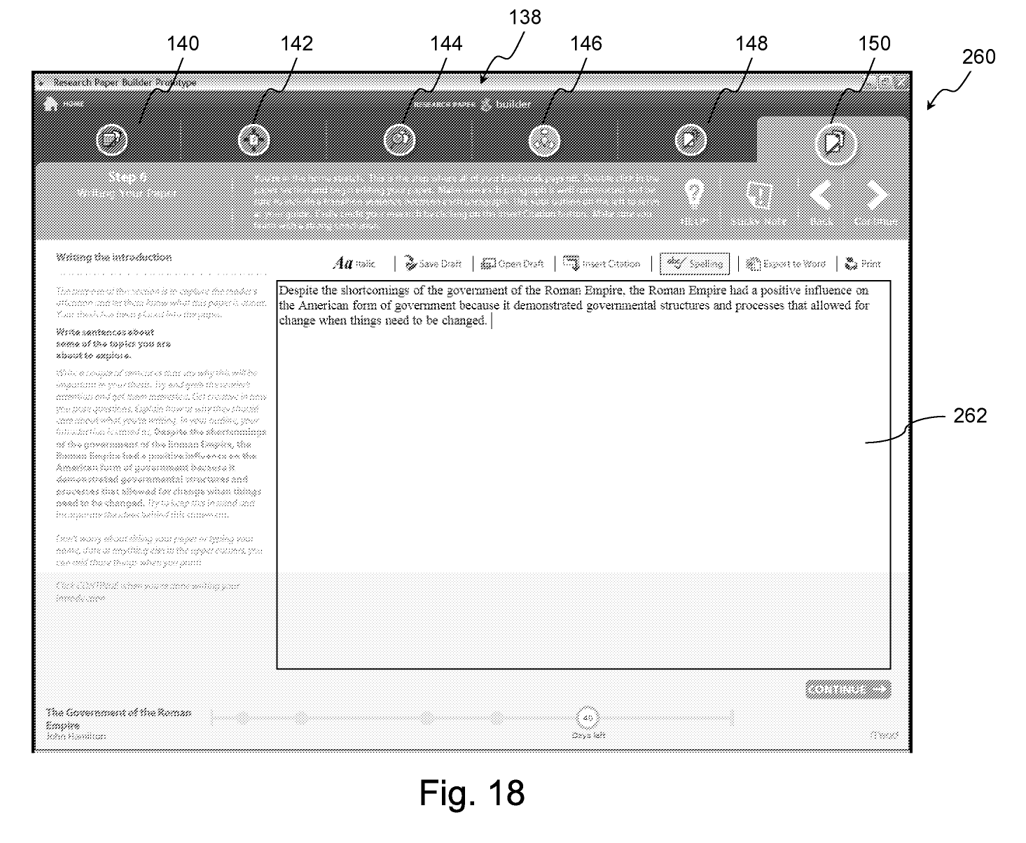

FIG. 18 illustrates an introduction page 260 accessible from within writing tab 150 of the graphical user interface of system 100. Once the user has completed the previous steps presented through planning tab 140, thesis tab 142, research tab 144, and organization tab 146, the user is presented with a series of pages that aid the user in writing the research paper, based on the research and organization accomplished in the previous pages. In one exemplary embodiment, the first writing page presented to the user is introduction page 260. Each of the writing pages may include a word processor window 262, which allows the user to enter and edit text. In one exemplary embodiment, introduction page 260 automatically inserts the thesis statement created by the user on thesis creation page 172 into word processor window 262. Word processor window 262 may include functionality for saving a draft of the research paper, opening a draft, inserting a citation, checking spelling, exporting the paper to a third party application, and printing the research paper. Introduction page 260 may also include instructions and help for the user in writing an appropriate introduction to the research paper. These instructions may be displayed adjacent to word processor window 262, as shown in FIG. 18.

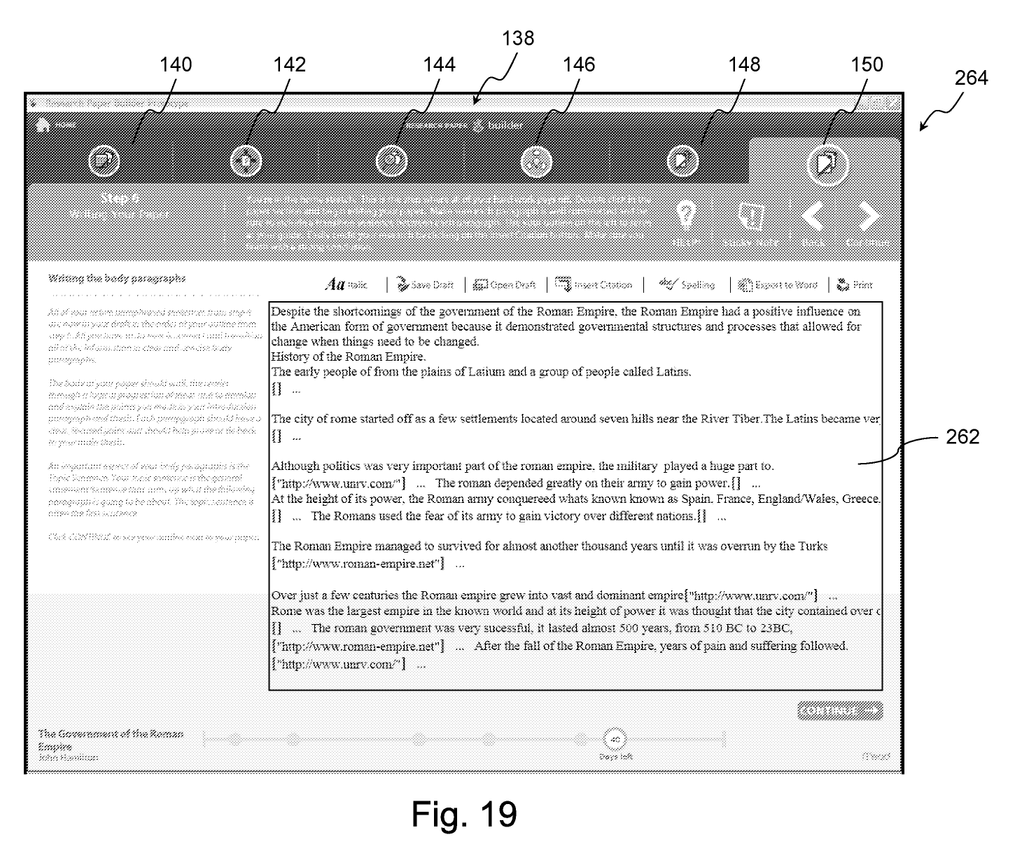

FIG. 19 illustrates a body paragraph page 264, which is presented to the user after introduction page 260 has been completed. Body paragraph page 264 also contains word processor window 262. The user may optionally be prompted to select whether they wish to insert quote 230 or paraphrase 232. In one exemplary embodiment, system 100 inserts all of the user's active paraphrased sentences entered from within research tab 144 in the order of the outline created from within outline tab 148. Because the user has associated each research note with a source, source citations may also be automatically inserted in the appropriate place within word processor window 262. Because all of the user's research quotes and/or paraphrases have automatically been entered, the user simply needs to connect and transition all of the information by editing the text to form clear and concise body paragraphs. As with introduction page 260, body paragraph page 262 may include instructions or other help about writing appropriate body paragraphs adjacent to word processor window 262, as shown in FIG. 19.

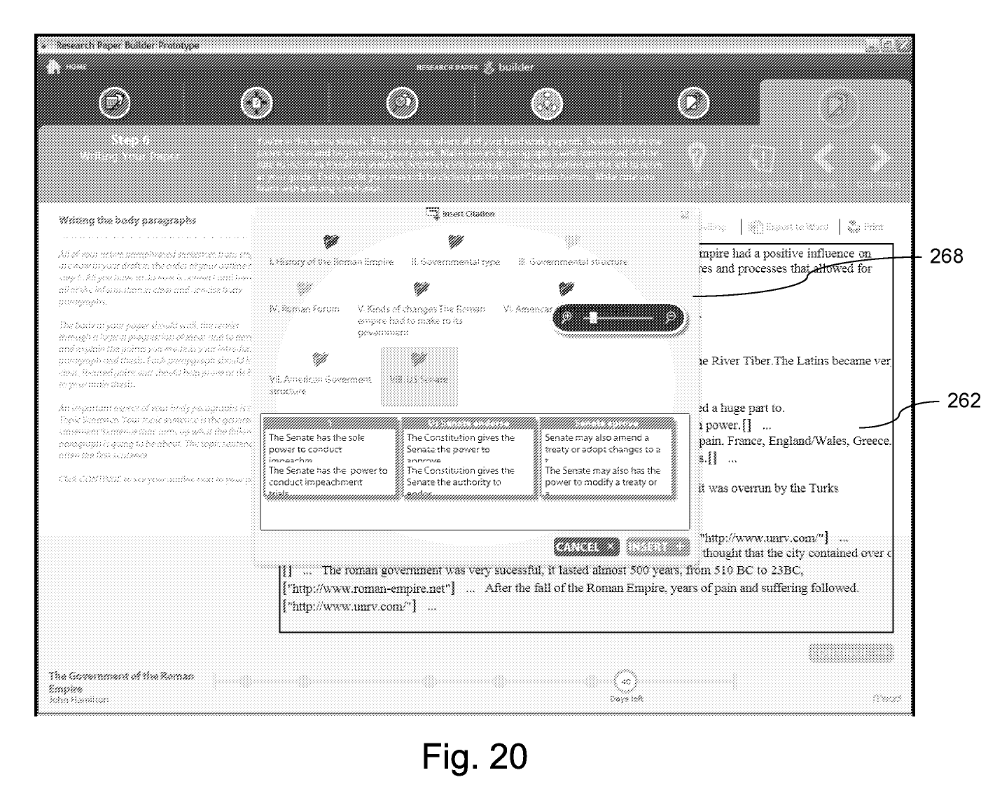

FIG. 20 illustrates the functionality for inserting citations of word processing window 262. Selecting an Insert Citation button 266 causes system 100 to display an Insert Citation window 268, which includes a list of all the sub-topic folders previously created by the user. Clicking or otherwise selecting a sub-topic folder causes the system to display all of the research cards 226 associated with the sub topic. Selecting a research card 226 will allow the user to either insert the direct quote or the paraphrase stored in the research card into word processing window 262.

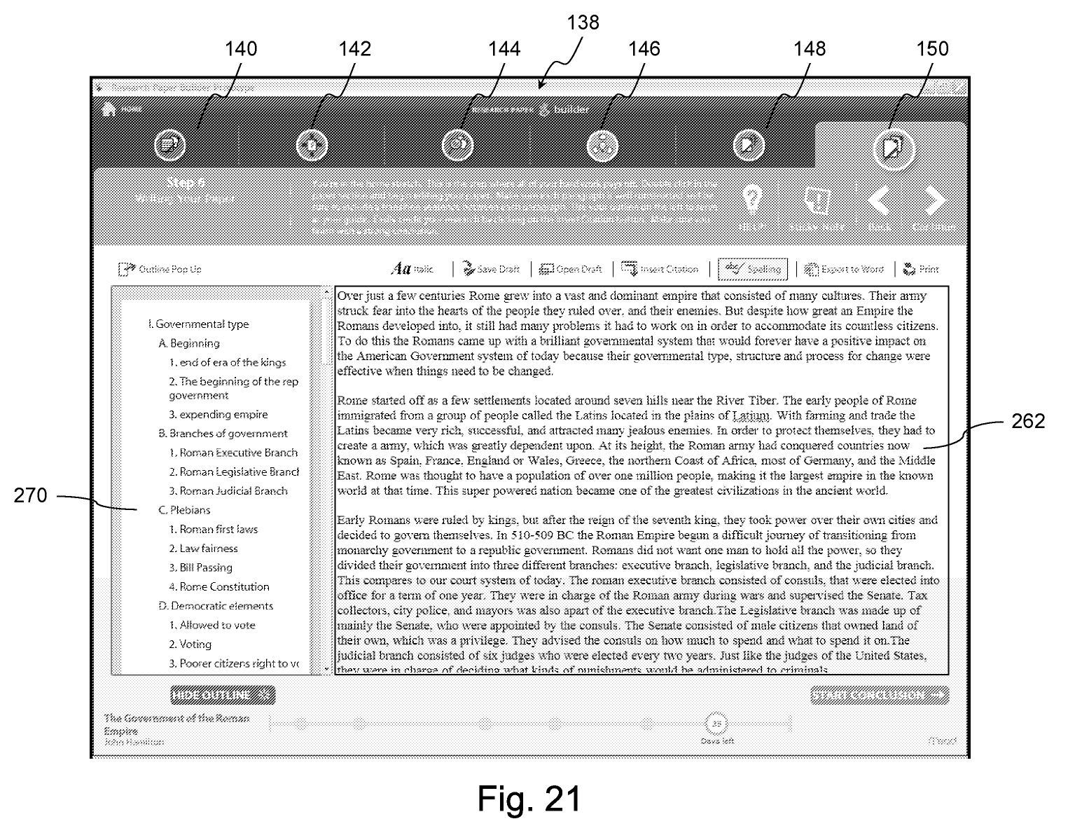

FIG. 21 illustrates word processing window 262 with an adjacent outline view 270. Outline view 270 displays the outline created and organized by the user from within outline tab 148. In one exemplary embodiment, outline view 270 coordinates with the display of the research paper in word processing window 262 such that selecting an item or sub item shown in outline view 270 will cause system 100 to display the corresponding portion of the research paper within word processing window 262. Additionally, the outline displayed within outline view 270 may be configured to provide access to the research cards 226 associated with each of the items and sub items in the outline. Outline view 270 may also include functionality for hiding the outline, or for displaying the outline in a separate pop-up window.

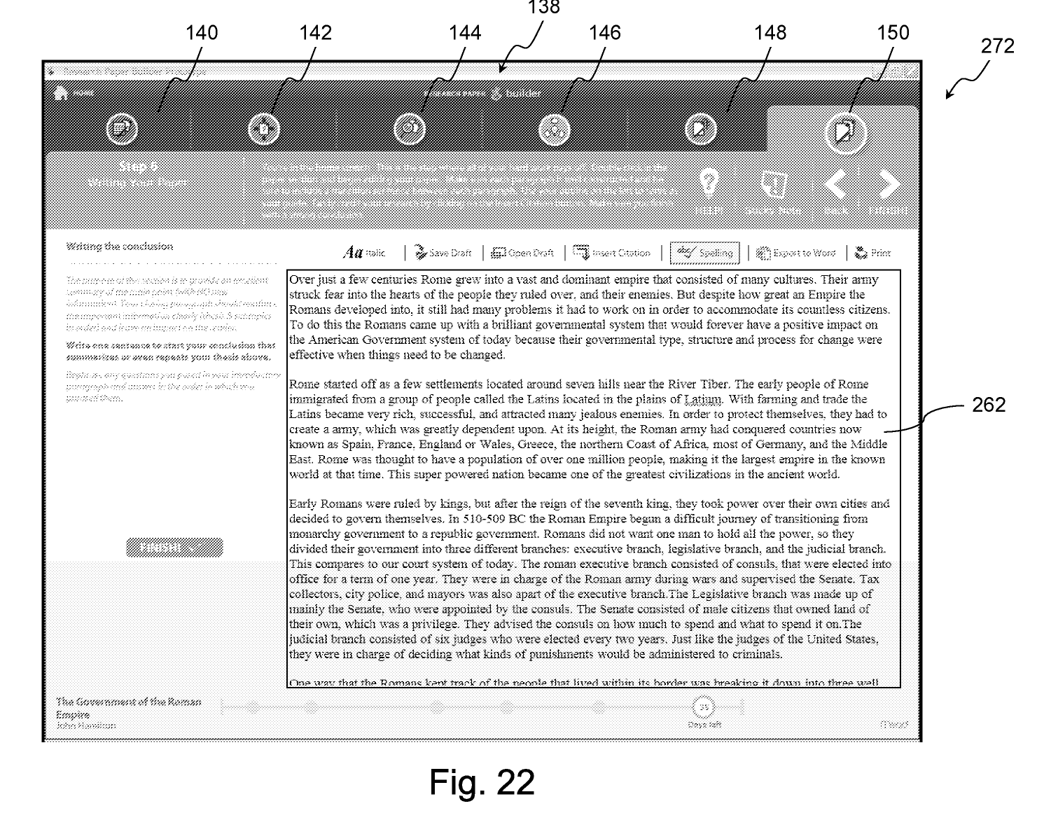

FIG. 22 illustrates a conclusion page 272, which is presented to the user after introduction page 272 has been completed. As with all of the other pages accessed within writing tab 150, conclusion page 272 contains word processor window 262, and may include instructions or other help about writing a concluding section of the research paper, displayed adjacent to word processor window 262, as shown in FIG. 22. Upon completion of the research paper, system 100 may provide the user with options for printing the paper, exporting the paper to an independent application, and sending an email with the paper attached.

The methods and systems of the present invention, as described above and shown in the drawings, provide for an intuitive and convenient technology platform for assisting a user in planning, researching, organizing, and writing a research paper. Although this disclosure discusses certain embodiments of the invention as they relate to research papers, the invention is not limited to use with research papers. The methods and systems of the present invention may be applied to any type of writing project. It will be apparent to those skilled in the art that various modifications and variations can be made to the systems and methods without departing from the scope of the invention as described in the appended claims and their equivalents.

The invention claimed is:

1. A system for assisting a user in organizing and writing a research paper, the system comprising:
a computer having a processor, a memory device, and a user interface, the computer being configured to run a plurality of modules and to receive input and provide output through the user interface;
a thesis module configured to run on the processor and to present a series of questions to the user, receive input regarding the series of questions, and to assemble a thesis statement based on the input received;
a research module configured to run on the processor and to output topics related to the thesis statement based on input from the user, to output research notes based on input from the user, and to assemble source citations based on input from the user, wherein the research module associates each of the research notes with at least one of the source citations;
an organization module configured to run on the processor and to edit the topics and research notes and to arrange the topics and the research notes within the topics in a predetermined order; and
a writing module configured to run on the processor and to create an editable draft of the research paper that includes at least the thesis statement and the content of the research notes arranged in the predetermined order.

2. The system of claim 1, further comprising a planning module configured to receive input from a user including a start date and a completion date for the research paper, and to create a timeline for completion of the research paper based on the start date and completion date, wherein the timeline includes a plurality of intermediate deadlines.

3. The system of claim 3, wherein the timeline is displayed through the user interface in an interactive format having movable icons representing each of the intermediate deadlines, wherein moving each of the movable icons along the timeline changes the amount of time between intermediate deadlines shown on the timeline.

4. The system of claim 1, further comprising an outline module configured to create an outline of the research paper based on the thesis statement and the arrangement of the topics in the predetermined order.

5. The system of claim 4, wherein the outline module is further configured to display the outline through the user interface in an interactive graphical format.

6. The system of claim 5, wherein the interactive graphical format of the outline includes functionality for creating, editing, and deleting topics and sub topics within the displayed outline.

7. The system of claim 6, wherein the interactive graphical format of the outline includes functionality for rearranging the topics and sub topics within the displayed outline.

8. The system of claim 1, further comprising at least one self-assessment module configured to present a series of assessment questions to the user, receive answers from the user, and output a self-assessment score and recommendations responsive to the answers received from the user.

9. The system of claim 1, wherein the thesis module is further configured to output an interactive graphical display with functionality that allows the user to create a new thesis statement and to edit an existing thesis statement.

10. The system of claim 9, wherein the interactive graphical display further includes functionality for duplicating a thesis statement, deleting a thesis statement, exporting a thesis statement to a word processing program, and printing a thesis statement.

11. The system of claim 1, wherein the research module is further configured to output an interactive graphical display with functionality that allows a user to enter information regarding at least one reference work and for allowing a user to create at least one reference note.

12. The system of claim 11, wherein the research module is further configured to automatically create a formatted list of source citations based on the inputted information regarding at the least one reference work.

13. The system of claim 1, wherein the organization module is further configured to output an interactive graphical display with functionality for editing the topics and for reordering the topics.

14. The system of claim 13, wherein the interactive graphical display outputted by the organizational module is configured to present a selectable list of the topics such that when a topic is selected, a research organization area will display a card representing each research note associated with the selected topic.

15. The system of claim 14, wherein the interactive graphical display outputted by the organizational module is further configured to allow user to edit the content of the cards associated with the selected topic.

16. The system of claim 14, wherein the interactive graphical display outputted by the organizational module is further configured to allow the user to rearrange the order of the cards associated with the selected topic.

17. The system of claim 1, wherein the writing module is further configured to output an interactive graphical display having a word processing area for displaying the editable draft of the research paper and an outline area displaying an outline of the research paper based on the thesis statement and the arrangement of the topics in the predetermined order.

18. A tangible computer readable medium storing an executable program configured to implement a method for assisting a user in organizing and writing a research paper, the method comprising:
presenting a series of questions to a user;
receiving input from the user for each of the questions;
assembling a thesis statement based on the input received from the user;
outputting topics based on input received from the user, the topics being related to the thesis statement;
creating source citations based on input from the user;
creating research notes based on input from the user;
associating each of the research notes with at least one of the source citations;
presenting an interactive graphical display configured to allow a user to arrange the topics in a predetermined order and to edit the research notes; and
creating an editable draft of the research paper that includes the thesis statement and the content of the research notes arranged in the predetermined order.

19. The tangible computer readable medium of claim 18, wherein the medium comprises a portable universal serial bus (USB) drive.

20. A computer-implemented method of assisting a user in organizing and writing a research paper, the method comprising:
displaying an interactive graphical display on a computer having a processor and a memory device;
running a thesis module using the processor, the thesis module configured to present a series of questions to the user and to receive input regarding the series of questions through the interactive graphical display;
using the processor to assemble a thesis statement based on the input received from the user;
running a research module using the processor, the research module configured to create topics related to the thesis statement based on input from the user, to create research notes based on input from the user, and to create source citations based on input from the user, and to associate each of the research notes with at least one of the source citations;
running an organization module using the processor, the organization module configured to present the topics in a predetermined order through the interactive graphical display and to allow the user to rearrange the topics in any order and to edit the research notes; and
running a writing module using the processor, the writing module configured to create an editable draft of the research paper that includes the thesis statement and the content of the research notes arranged according to the predetermined order.
